(19) United States
(12) Patent Application Publication
(10) Pub. No.: US 2023/0160183 A1
(43) Pub. Date: May 25, 2023

(54) System for Tracking Earthmoving Progress

(71) Applicant: Thomas Rush, Houston, TX (US)

(72) Inventor: Thomas Rush, Houston, TX (US)

(21) Appl. No.: 18/058,268

(22) Filed: Nov. 22, 2022

Related U.S. Application Data
(60) Provisional application No. 63/281,813, filed on Nov. 22, 2021.

(51) Int. Cl. E02F 9/26; G05D 1/00

(52) U.S. Cl. CPC E02F 9/261; G05D 1/0094; G05D 2201/0202

(57) ABSTRACT

Disclosed is an integrated sensing device for determining information about a work site where earthmoving and excavation may be taking place. In one embodiment, the integrated sensing device includes optical sensors, variable range detection, and a position sensor. The sensing device may be mounted to an earth moving machine, and the methods for use include making measurements of excavated trenches, excavated soil volume, and location of potential worksite hazards. The data collected by the integrated sensing device can be synchronized with external databases. This allows for improved productivity tracking and worksite safety compliance at earth moving work sites.

### BACKGROUND OF THE INVENTION

At least one specification heading is required. Please delete this heading section if it is not applicable to your application. For more information regarding the headings of the specification, please see MPEP 608.01(a). Earthmoving and construction industries often suffer from inefficiencies in operation, and difficulties in accurately tracking the progress of machinery operators at work sites. For example, it is difficult for operators to determine the amount of digging soil removed by equipment at worksites, which can lead to inefficient utilization of hauling equipment, leading to increased cost and time required to complete an excavation.

In addition, there are numerous safety hazards present at work sites in which earth moving activity occurs, and the dynamic environment of the site means that hazards must be continually monitored to ensure compliance with workplace safety regulations. For instance, a crew at a work site is required to maintain certain trench geometries to reduce the risk of trench collapse and injury to persons at the work site. These geometries must be maintained while a trench is excavated.

Therefore, there is a need for systems and improved methods that can track the performance and progress of earthmoving activities to improve efficiency and safety of these operations.

### SUMMARY OF THE INVENTION

In general terms, the present disclosure is directed toward an integrated sensing device that can be adapted to be used in conjunction with earth-moving equipment at a work site where excavation activity may be taking place. Such a sensing device uses a variety of sensor inputs in conjunction with processing and memory circuits to determine and store information about the work site towards the goal of improving the productivity and safety of the work site.

In an aspect of the present disclosure, an integrated sensing device is disclosed that includes an imaging sensor, a networking interface, a digital variable range detection system, a processing circuit, and a memory circuit.

In some examples the device uses a stereoscopic camera as an imaging device, a light ranging and detection system (LIDAR) as the range detection system, and a cellular modem as a networking interface.

In some examples, the sensing device can also include a positioning device, such as a Global Navigation Satellite System (GNSS) receiver.

In some examples, the sensing device includes a housing with which all components are installed, which enables placement on an earthmoving machine.

A method for operating a sensing device includes directing the sensing device, which includes imaging and digital range detection toward an excavator bucket. A processing circuit and memory circuit receive data outputs from the imaging and range detection sensors, then determines the position of excavator arms and the bucket and creates a surface model of the bucket. The processing circuit and memory circuit can then determine the contents of the bucket by comparing the surface model against previous data.

In some examples the method can include determination of the material composition of the bucket contents.

In some examples the method includes transmitting data from the processing circuit and memory circuit through the networking interface to a cloud database through an event handler.

Another method includes using the integrated sensing device Including an imaging sensor, variable range detection system, processing circuit, and networking interface, to create a surface model of a work sit

In some examples, the method includes determining the critical dimensions of a trench present within the model and determining whether these dimensions comply with previously established limits.

In some examples, the method includes determining whether electrical power transmission lines or suspended loads are present within the surface model and determines their location relative to the sensing device.

In some examples, the method includes determining if a pipe segment is present with the surface model, and includes determination of the composition, length, and width of the pipe segment.

In some examples, the method includes transmitting data from the processing circuit and memory circuit to a cloud database using a networking interface and a data handler.

### BRIEF DESCRIPTION OF DRAWINGS

FIG. 1 is a schematic diagram of a representative sensor system

FIG. 2 is a schematic diagram of an illustrative network with a representative sensor system.

FIG. 3 is an illustration of a method for using the disclosed system with an excavator for soil measurement.

FIG. 3A illustrates a method for system calculation of a loaded excavator bucket

FIG. 3B depicts a method for the creating a model of an empty excavator bucket

FIG. 3C depicts a method for updating a model of an empty bucket to account for changes in the apparent capacity

FIG. 4 is an illustration of a method for using the disclosed system for detecting objects placed in the ground.

FIG. 5 is an illustration of a method for using the disclosed system for assessing worksite safety risks.

FIG. 6 is an illustration of a method for using the disclosed system to create and update a survey model.

FIG. 7 is a flow chart of some of the important steps performed by the disclosed system in example methods of using said system

### DETAILED DESCRIPTION OF THE INVENTION

Note that the specific embodiments given in the drawings and following description do not limit the disclosure. On the contrary, they provide the foundation for one of ordinary skill to discern the alternative forms, equivalents, and modifications that are contemplated by the inventors and encompassed in the claim scope.

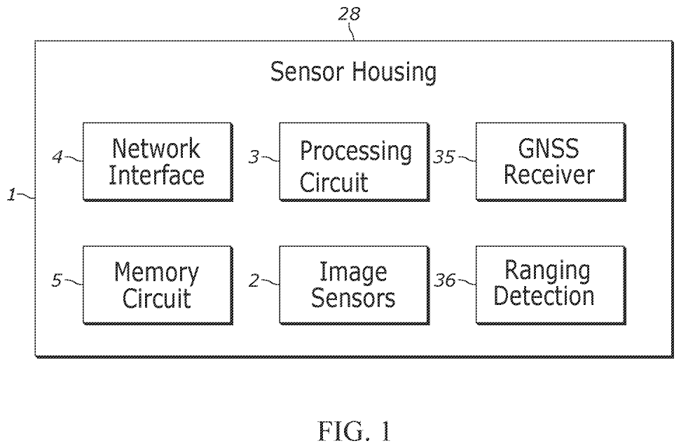

FIG. 1 discloses one embodiment of an integrated sensing device 1 comprising image sensors 2, a processor 3, a networking interface 4, a local storage database 5, a GPS receiver 35, and LiDAR sensors 36, contained in a housing 28. The sensors 2 may comprise an optical stereo imaging camera.

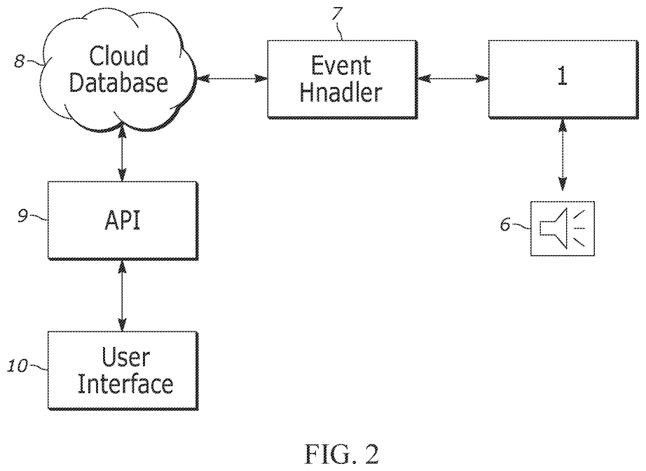

FIG. 2 is a schematic of a network configuration for the sensor system 1 in context. If the sensor system 1 detects an unsafe configuration at the worksite, the system can trigger an audible alarm 6. The sensor system collects data and syncs data and events with a cloud database 8 through an event handler 7. The cloud database 8 is referenced via an application programming interface 9 to a client portal or user interface 10.

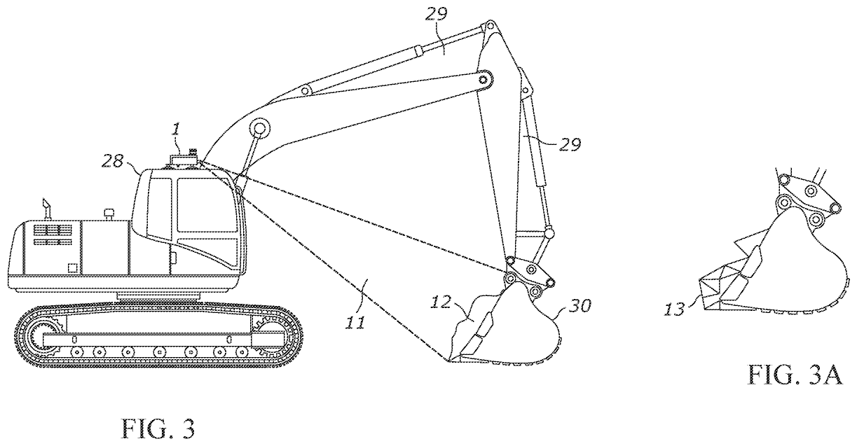

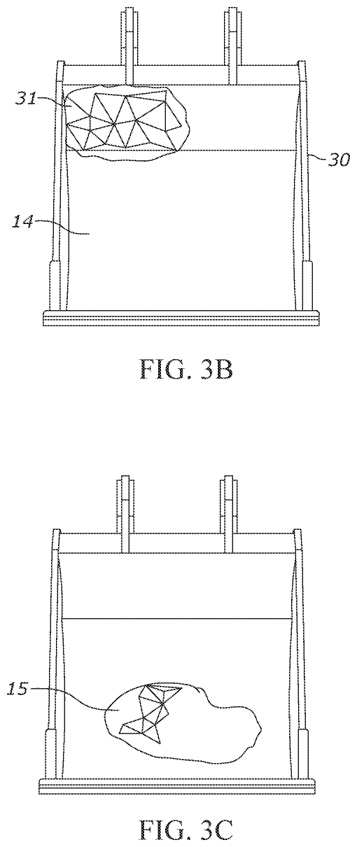

FIG. 3 depicts the disclosed sensor system 1 mounted on top of the cab portion 28 of an excavator. The sensor system 1 scans the area in front of its field of view 11. To measure the contents 12 of an excavator bucket 30, the sensor system first detects the positions of the excavator arms 29 and bucket 30. Once said positioning is recognized, the sensor system scans the contents 12 of the bucket 30 and determines whether the bucket is in a loaded or empty state. If the empty state is detected, the system creates surface models 31 of the empty bucket interior 14 using data from the image sensors 2 and the LiDAR sensors 36. The surface models 31 are then updated in the local database 5. When the system determines the bucket is empty or unloaded, system creates a new model of the bucket interior 14 and overlays the new model to looks for outliers 15 such as material that is stuck to the back of the bucket as shown in FIG. 3C. A living model of the bucket interior is thus updated with each scan of the unloaded bucket.

If the sensor system detects the bucket 30 is loaded with contents 12, the system creates a volumetric model of the loaded bucket 13 (FIG. 3A) from image sensor 2 and LiDAR sensor 36 data then and compares the loaded bucket model 13 against the living model of the empty bucket interior 31 to isolate and determine the volume of the bucket contents 12. The system can use the data from the image sensors 2 to identify the composition of the bucket contents 12 by comparing the apparent texture and color of the contents against database information. The volume calculation and composition of the contents are read and stored to the local database 5.

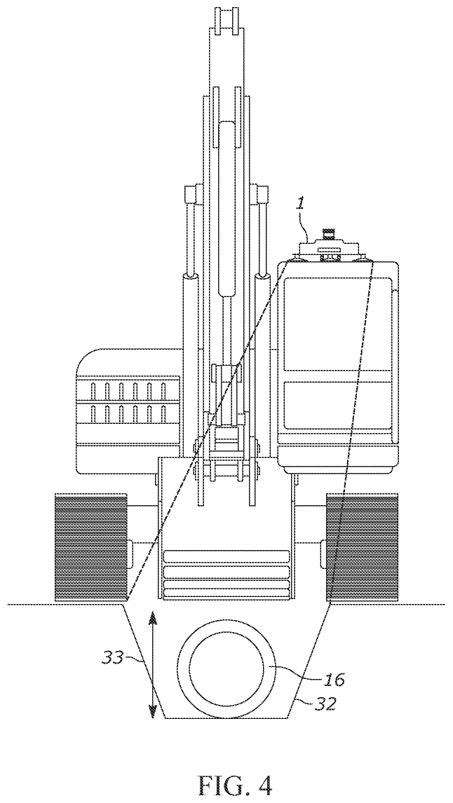

FIG. 4 depicts the sensor system 1 scanning a pipe installation 16. The system uses object detection-based data from the image sensors 2 and LiDAR sensors 36 including reflectivity, color, measured width to length ratio, and dynamic apparent stiffness of the pipe to recognize pipe segments. Once the pipe 16 is placed at its installation location 32 the system records the length of the pipe, type of pipe, and depth of the pipe installation 33 to the local database 5.

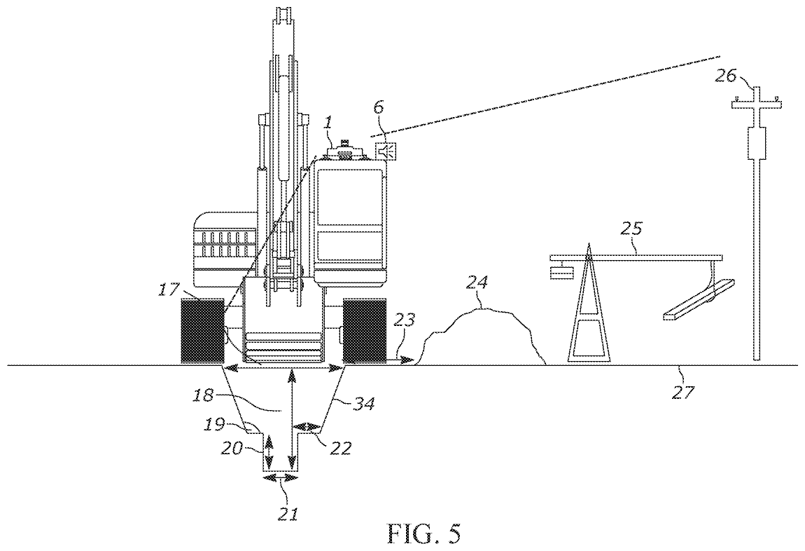

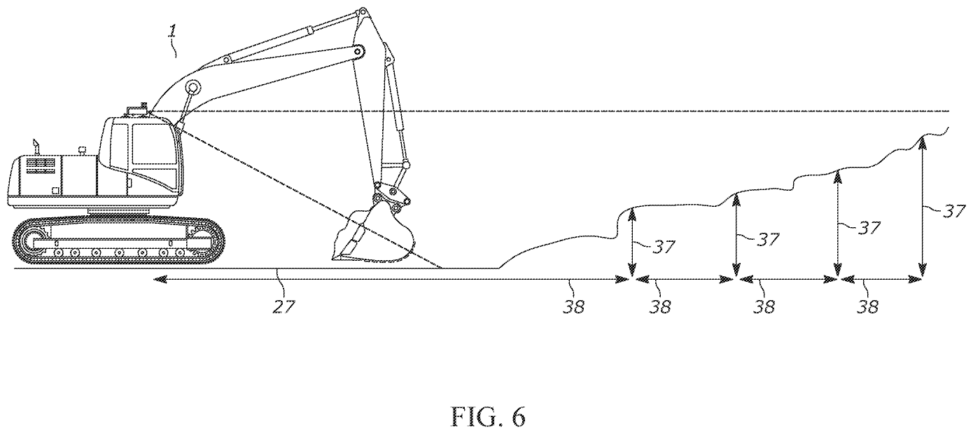

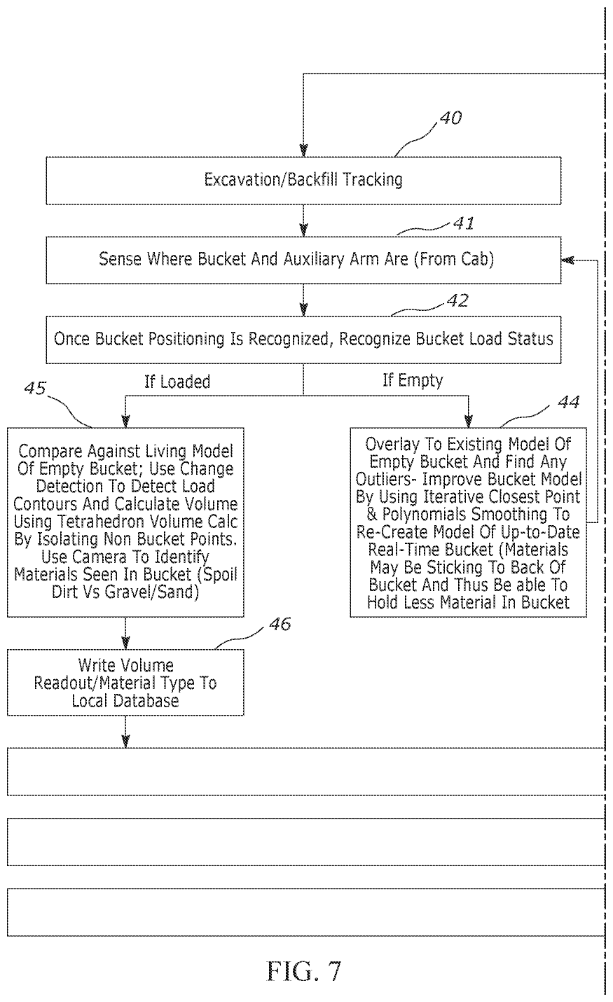

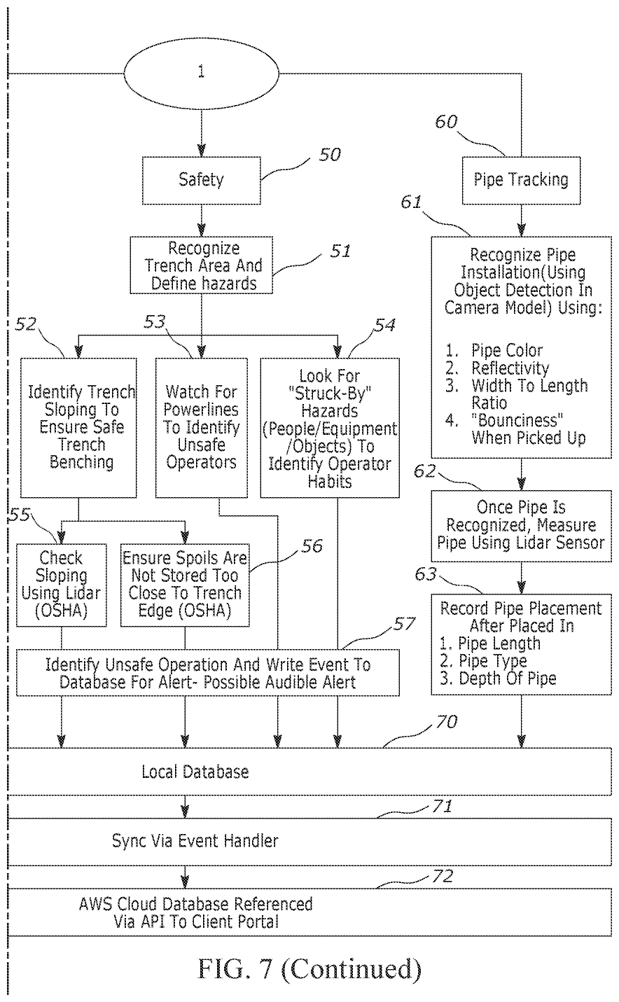

FIG. 5 depicts how the sensor system 1 detects various safety hazards while operating at a worksite 27. The system can measure worksite trench 34 dimensions such as trench width 17, slope angle 19, trench depth 18, benching width 22, benching height 21, trench lower portion depth 20 and lower portion width 21. The system can detect the distance 23 excavated spoils 24 are located relative to the edge of a worksite trench 34. The system also detects “struck-by” hazards including suspended loads 25 and identifies the location of power lines 26. In the event an unsafe worksite condition is detected, the system writes an event to the local database 5 and can issue an audible alarm 6.

FIG. 6 depicts how the sensor system 1 creates and updates a survey model of the worksite 27. The system 1 uses its onboard image sensors 2, LiDAR 36 and GPS 35, combined based on image object detection to create measurements of terrain elevations 37 and positions 38 relative to system. This measurement data is stored and uploaded to the cloud database for further processing into living survey models, allowing for site progress to be realized in real time.

Numerous alternative forms, equivalents, and modifications will become apparent to those skilled in the art once the above disclosure is fully appreciated. It is intended that the claims be interpreted to embrace all such alternative forms, equivalents, and modifications where applicable.

What is claimed is:

1. An integrated sensing device comprising:
a. an imaging sensor;
b. a networking interface;
c. a digital variable range detection system; and
d. a processing circuit, and a memory circuit; and
e. wherein said processing circuit is configured
i. to receive output signals from said imaging sensor, and said range detection system.

2. The integrated sensing device of claim 1, wherein said digital variable range detection sensor comprises a light ranging and detection system (LIDAR).

3. The integrated sensing device of claim 1, wherein said imaging sensor comprises an optical stereo imaging camera.

4. The integrated sensing device of claim 1, wherein said networking interface comprises a cellular modem.

5. The integrated sensing device of claim 1, further comprising a position sensor.

6. The integrated sensing device of claim 1, further comprising a housing wherein:
a. said imaging sensor, said networking interface, said digital variable range detection system, said processing circuit, and said memory circuit are all installed with said housing; and
b. said integrated sensing device is mounted to an earthmoving machine.

7. The integrated sensing device of claim 6, wherein said position sensor comprises a Global Navigation Satellite System (GNSS) receiver.

8. The integrated sensing device of claim 1, wherein said networking interface is further configured:
a. to receive output signals from the processing circuit; and
b. to provide output data to an external database via an event handler.

9. The integrated sensing device of claim 6, wherein said processing circuit is further configured to receive outputs from said position sensor.

10. A method of using an integrated sensing device, said method comprising:
a. providing an integrated sensing device, having:
i. an imaging sensor;
ii. a digital variable range detection system;
iii. a processing circuit;
iv. a memory circuit; and
v. a networking interface;
b. directing said sensing device toward an excavator bucket, and said imaging sensor and said variable range detection system provide outputs to said processing circuit;
c. said processing circuit and said memory circuit determine the position of excavator arms attached to said bucket and creates a surface model of said bucket; and
d. said processing circuit and said memory circuit determines the volume of the contents of the bucket by comparing the surface model against previously gathered data.

11. The method of claim 11 further comprising the steps of:
a. said processing circuit and said memory circuit determining the approximate material composition of the bucket contents from data input from said imaging sensor.

12. The method of claim 11 further comprising the steps of:
a. Transmitting data from said processing circuit and said memory circuit through said networking interface to a cloud database through an event handler.

13. A method of using an integrated sensing device, said method comprising:
a. providing an integrated sensing device, having:
i. an imaging sensor;
ii. a digital variable range detection system;
iii. a processing circuit;
iv. a memory circuit; and
v. a networking interface;
b. directing said sensing device toward a work site, and said imaging sensor and said variable range detection system provide outputs to said processing circuit; and
c. creating a surface model of said work site using said processing and memory circuit.

14. The method of claim 13 further comprising the steps of:
a. determining the critical dimensions of a trench present within said surface model using said processing and memory circuit;
b. determining if said critical dimensions are within a programmed acceptable limit using said processing and memory circuit.

15. The method of claim 13 further comprising the steps of:
a. identifying the critical dimensions of a trench present within said surface model using said processing and memory circuit.

16. The method of claim 13 further comprising the steps of:
a. determining if electrical power transmission lines are present within said surface model and their location relative to sensing device using said processing and memory circuit; and
b. determining if suspended loads are present within said surface model, then determining their location relative to sensing device using said processing and memory circuit.

17. The method of claim 13 further comprising the steps of:
a. identifying and determining if a pipe segment is present within said surface model using said processing and memory circuit; and
b. determining the composition, length, width of said pipe segment using said processing and memory circuit.

18. The method of claim 13 further comprising the steps of:
a. Transmitting data from said processing circuit and said memory circuit through said networking interface to a cloud database through an event handler.
